(19) United States
(12) Patent Application Publication
(10) Pub. No.: US 2026/0192762 A1
(43) Pub. Date: Jul. 9, 2026

(54) WIRING HARNESS FOR SEAT BELT OF A VEHICLE

(71) Applicant: Honda Motor Co., Ltd., Tokyo (JP)

(72) Inventor: TRAVIS M. REEL, Ostrander, OH (US)

(21) Appl. No.: 19/014,794

(22) Filed: Jan. 9, 2025

(51) Int. Cl. B60R 16/02; B60R 22/26

(52) U.S. Cl. CPC B60R 16/0215; B60R 22/26

(57) ABSTRACT

A wiring harness includes a tube that includes a first end disposed inside a webbing-type buckle of a seat belt of the vehicle. The wiring harness further includes several electric wires disposed inside the tube. The wiring harness further includes an internal reinforcement member, which influences harness bending and durability.

### BACKGROUND

A wiring harness, also known as a cable harness, electrical harness, or wiring loom, is an assembly of electrical wires or cables that transmit signals or electrical power. These wires and cables are meticulously bound together using various methods such as straps, cable ties, conduits, sleeves, tape, or a combination thereof to ensure the wires or cables remain organized and protected. Wiring harnesses are integral components in automobiles, machinery, and a wide array of electronic devices, providing reliable and efficient electrical connections. They are specifically designed to enhance the durability and lifespan of the enclosed electrical wires.

In the automotive industry, wiring harnesses are pivotal to the functionality and safety of vehicles. A notable application is in seat belt reminder systems installed in the seats of a vehicle. These systems are subject to the dynamic movements of passengers, which can lead to premature failures of the wiring harness. This issue typically arises from the integration of the wiring harness with webbing-type buckles. The movement of the webbing-type buckles by passengers directly impacts the wiring harness, causing it to bend repeatedly over a small radius. This continuous bending exerts stress on the electrical wires, eventually leading to their premature failure. Thus, increasing the bend radius is one way to improve the durability of the wiring harness. This necessitates developing a wiring harness that promotes a larger bending radius. The wiring harness must resist sharp bending and improve the longevity of the electrical wires.

Further limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an aspect of the disclosure, a wiring harness for a vehicle may be provided. The wiring harness may include a tube that may include a first end disposed inside a webbing-type buckle of a seat belt of the vehicle. The wiring harness may further include a plurality of electric wires that may be disposed inside the tube. Further, each wire of the plurality of electric wires may extend along a first length of the tube. The wiring harness may further include an internal reinforcement member that may be disposed along a second length of the plurality of electric wires inside the tube.

According to another aspect of the disclosure, a webbing type buckle of a seat belt of a vehicle may be provided. The webbing type buckle may include wiring harness that may include a tube that may include a first end disposed inside a webbing-type buckle of a seat belt of the vehicle. The wiring harness may further include a plurality of electric wires that may be disposed inside the tube. Further, each wire of the plurality of electric wires may extend along a first length of the tube. The wiring harness may further include an internal reinforcement member that may be disposed along a second length of the plurality of electric wires inside the tube.

According to yet another aspect of the disclosure, a method of assembling a wiring harness inside a webbing-type buckle for a vehicle may be provided. The method may include disposing a plurality of electric wires inside a tube. Further, each wire of the plurality of electric wires may extend along a first length of the tube. The method may further include disposing an internal reinforcement member along a second length of the plurality of electric wires inside the tube. The method may further include disposing a first end of the tube inside the webbing-type buckle of a seat belt of the vehicle.

### BRIEF DESCRIPTION OF THE DRAWINGS

FIG. 1 is a diagram that illustrates a perspective view of an exemplary seat of a vehicle having a wiring harness, in accordance with an embodiment of the disclosure.

FIG. 2 is a diagram that illustrates a sectional view of a webbing-type buckle including a wiring harness and a seat belt of a vehicle, in accordance with an embodiment of the disclosure.

FIG. 3 is a diagram that illustrates a cross-sectional view of a wiring harness including an internal reinforcement member having a T-shaped cross-section, in accordance with an embodiment of the disclosure.

FIG. 4 is a diagram that illustrates a cross-sectional view of a wiring harness including an internal reinforcement member having a rectangular cross-section, in accordance with an embodiment of the disclosure.

FIG. 5 is a diagram that illustrates a cross-sectional view of a wiring harness including an internal reinforcement member having a first circular cross-section, in accordance with an embodiment of the disclosure.

FIG. 6 is a flowchart that illustrates an exemplary method of assembling a wiring harness inside a webbing-type buckle for a vehicle, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

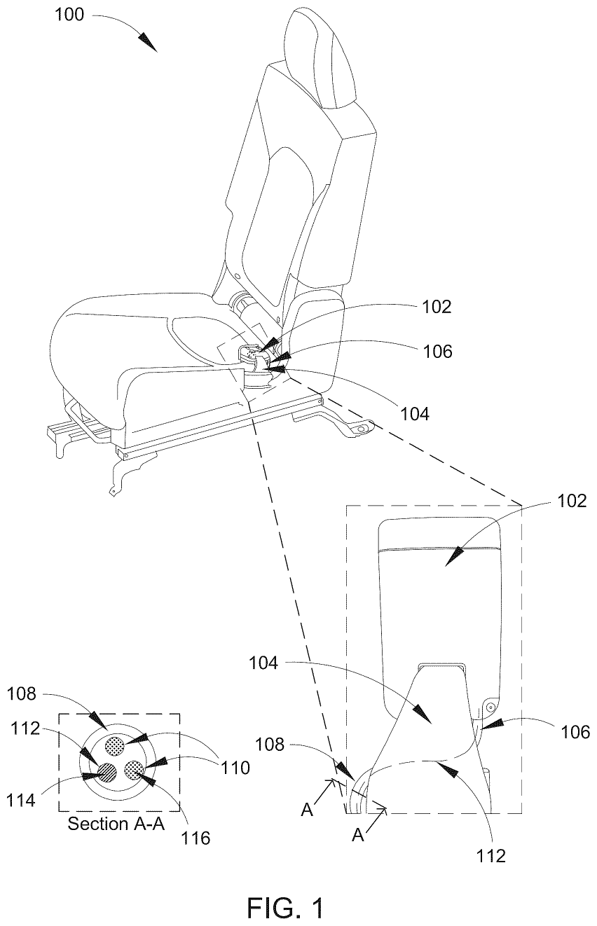

FIG. 1 is a diagram that illustrates a perspective view of an exemplary seat of a vehicle having a wiring harness, in accordance with an embodiment of the disclosure. With reference to the FIG. 1, there is shown a diagram that illustrates a seat 100 of a vehicle. The seat 100 may include a webbing-type buckle 102, a seat belt 104, a wiring harness 106, a tube 108, and a plurality of electric wires 110 disposed inside the tube 108. The tube 108 may include an internal reinforcement member 112 that is illustrated in detail about an A-A section.

The seat 100 of the vehicle may include a bucket seat, or a bench seat with a contoured platform designed to seat up at least one of a single person or two persons (or even more than two persons). For example, the bucket seat may be designed to accommodate a single person, and the bench seat may be designed to accommodate up to three persons. By way of example, and not limitation, the bucket seat may correspond to at least one of a driver seat or a passenger seat in the front cabin of the vehicle. In a preferred embodiment, the seat 100 may be the bench seat in the rear cabin of the vehicle. The seat 100 may typically have rounded backs and may offer a variety of adjustments to fit different sized persons. The seat 100 may further include a seat structure (not shown) comprising a plurality of components, such as but not limited to, a pair of bracket headset holder, a head rest panel, a front panel cushion, a side frame front panel, a rear frame cushion, a top panel cushion, brackets, a regular level, or a slide adjuster. The description of the plurality of components of the seat structure has been omitted from the disclosure for the sake of brevity.

The seat 100 of the vehicle may include a supplemental restraint system (SRS), that may be realized through several known safety technologies, such as, but not limited to a seat belt 104. The seat 100 may further include the webbing-type buckle 102, the seat belt 104, and the wiring harness 106.

The webbing-type buckle 102 may be a fastening device designed to work with webbing straps, which may be flat or woven strips of fabric. The webbing-type buckle 102 may be configured to secure, adjust, and release the webbing straps easily. The webbing-type buckle 102 may have a rectangular cross section with circular edges. Alternatively, the cross section of the webbing-type buckle 102 may have another suitable shape, such as but not limited to, a circular shape or a square shape. The webbing-type buckle 102 may be commonly found in various applications such as automobiles, outdoor gear, luggage, safety equipment, and apparel. In a preferred embodiment, the webbing-type buckle 102 may be used to secure the seat belt 104 to the seat 100 of the vehicle.

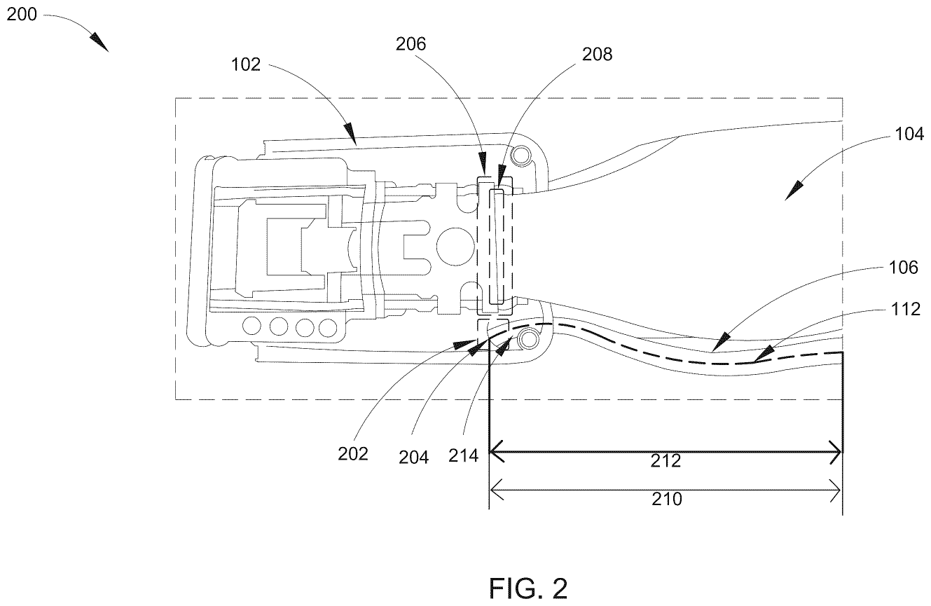

The seat belt 104 may be a vehicular safety device designed to secure a user or an occupant on the seat 100, thereby minimizing the risk of injury or fatality during a collision or abrupt deceleration of the vehicle. The seat belt 104 may be placed on a bucket seat to secure at least single person in a front cabin of the vehicle. Additionally, the seat belt 104 may be placed on a bench seat to secure up to three persons in a rear cabin of the vehicle. The seat belt 104 may include a webbing strap, a buckle mechanism, a retractor, anchor points, and may include additional features such as pretensioners and load limiters. The seat belt 104 may further include a seat belt structure comprising a plurality of components, such as but not limited to, a webbing strap, a buckle mechanism, a retractor, anchor points, a pretensioner, or a load limiter. The description of the plurality of components of the seat belt structure has been omitted from the disclosure for the sake of brevity. The seat belt 104 may be secured to a second portion (a second portion 206 as shown in FIG. 2) of the webbing-type buckle 102 having a slot (a slot 208 as shown in FIG. 2), as further described, in detail, for example in FIG. 2.

The wiring harness 106 may be a cable harness or wire harness that may be an assembly of electrical cables or wires that transmit signals or electrical power. The cables or wires may be bound together by various means such as straps, cable ties, conduits, sleeves, tape, or a combination thereof to keep the cables or wires organized and protected. The wiring harness 106 may be used in a wide range of applications, including automobiles, aircraft, construction machinery, and household appliances. The wiring harness 106 simplifies the manufacturing process of the devices by integrating multiple wires into a single unit, which may be easily installed and connected. Additionally, the wiring harness 106 may improve safety and reliability by protecting the wires from abrasion, moisture, and other environmental factors. Key components of a wiring harness may include, for example, wires/cables, connectors, terminals, protective sleeves/conduits, and the like. The wiring harness 106 may be essential for ensuring the efficient and safe operation of electrical systems in various applications. The wiring harness 106 may be disposed inside the webbing-type buckle 102 of the seat belt 104 of the vehicle. The wiring harness 106 may further include the tube 108.

The tube 108 may be a tubular, flexible covering made from materials such as plastic, rubber, or fabric. The tube 108 may be essential in various applications to ensure safety, durability, and efficiency of electrical systems. The tube 108 may be a protective covering used to insulate, organize, and safeguard the plurality of electric wires 110. Furthermore, the tube 108 may be designed to encase a plurality of electric wires 110, protecting the plurality of electric wires 110 from physical damage and resisting environmental factors such as moisture, heat, and chemicals. The tube 108 may be applied on the plurality of electric wires 110 using a suitable method, such as a heat shrink tubing process or a corrugated tubing or spiral wrap. The tube 108 may have substantially circular cross section. Alternatively, the cross section of the tube 108 may have another suitable shape, such as but not limited to, an elliptical shape, a rectangular shape or a square shape.

The tube 108 may include a first end (a first end 214 as shown in FIG. 2) disposed inside the webbing-type buckle 102 of the seat belt 104 of the vehicle. A second end of the tube 108 may be connected to electrical systems of the vehicle, such as but not limited to a sensor system. For instance, when the sensor system detects a collision, control circuity installed within the vehicle instantly actuates a pretensioner that uses an explosively and expanding gas to drive a piston that retracts the seat belt 104. Additionally, or alternatively, the wiring harness 106 having the tube 108 may be used in a different vehicle system, such as but not limited to, Electronic Stability Control (ESC), Anti-lock Braking System (ABS), Airbags, Tire Pressure Monitoring System (TPMS), Power Management System, Communication Systems, Infotainment System, Climate Control System, Ignition System, or Charging System. The tube 108 may be configured to secure the plurality of electric wires 110.

The plurality of electric wires 110 may be disposed inside the tube 108. Each wire of the plurality of electric wires 110 may extend along a first length (a first length 210 as shown in FIG. 2) of the tube 108. The plurality of electric wires 110 may be conductors that carry electrical current from a sensor system of the vehicle to the control circuitry to actuate the pretensioner of the webbing type buckle. Additionally, or alternatively, the plurality of electric wires 110 may be used in for different vehicle systems. The plurality of electric wires 110 may typically be made of materials with high electrical conductivity, such as copper or aluminum. The plurality of electric wires 110 may be used in a wide range of applications, from household electrical systems to industrial machinery and power transmission.

The plurality of electric wires 110 may further include an insulation and a sheath that acts as protective layer to prevent the conductor from electrical leakage, short circuits, and environmental factors. A cross section of each wire of the plurality of electric wires 110 may be circular.

The internal reinforcement member 112 may be a structural component that provides additional strength, support, or stability to the wiring harness 106. The internal reinforcement member 112 may be disposed along a second length (a second length 212 as shown in FIG. 2) of the plurality of electric wires 110 inside the tube 108. In an embodiment, the internal reinforcement member 112 may be at least one of a plastic spine, a composite reinforcement, or a fiberglass reinforcement.

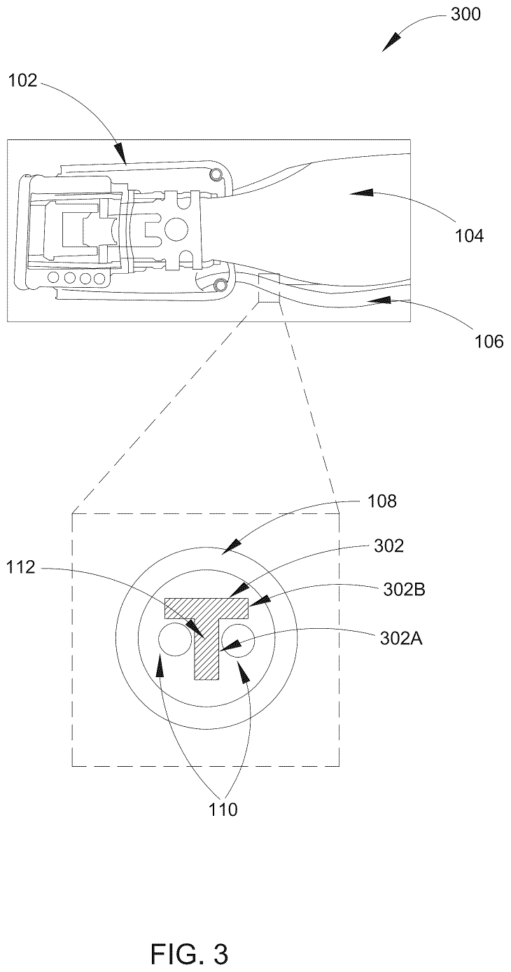

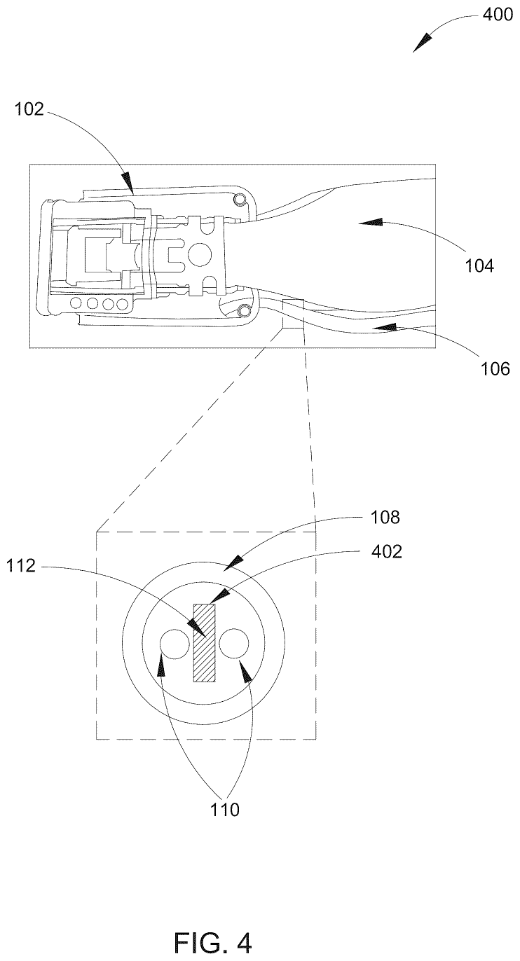

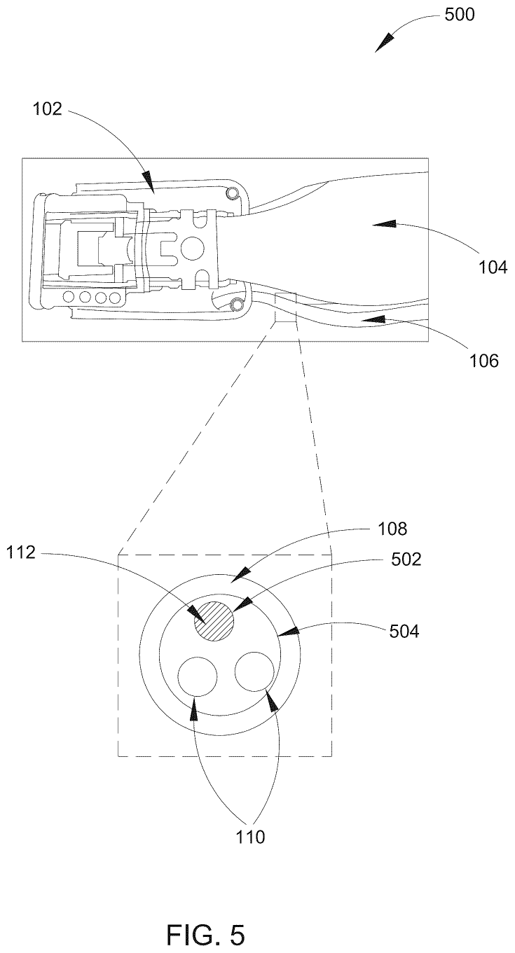

The internal reinforcement member 112 may have various cross sections (T-shaped, I-shaped, circular-shaped, etc.), as further described, in detail, for example in FIG. 3, FIG. 4, and FIG. 5. The internal reinforcement member 112 may be configured to constrain a bending of the plurality of electric wires 110. For instance, the webbing-type buckle 102 may be subjected to bends caused due to movement of a user seated over the seat 100. The internal reinforcement member 112 may be configured to resist sharp bending (for example, bends having smaller bend radius) of the wiring harness 106. The internal reinforcement member 112 may be configured to allow larger bending radius of the wiring harness 106 that prevents premature failures of the wiring harness 106.

In accordance with an embodiment, a cross-sectional area 114 of the internal reinforcement member 112 may be greater than a total cross-sectional area 116 of the plurality of electric wires 110. In accordance with another embodiment, the cross-sectional area 114 of the internal reinforcement member may be less than the total cross-sectional area 116 of the plurality of electric wires 110.

FIG. 2 is a diagram that illustrates a sectional view of a webbing-type buckle including a wiring harness and a seat belt of a vehicle, in accordance with an embodiment of the disclosure. FIG. 2 is explained in conjunction with elements from FIG. 1. With reference to the FIG. 2, there is shown a diagram 200 that illustrates sectional views of the webbing-type buckle 102 having the wiring harness 106 and the seat belt 104 of the vehicle. The diagram 200 further includes a first portion 202, an aperture 204, a second portion 206, a slot 208, a first length 210, a second length 212, and a first end 214.

The webbing-type buckle 102 may include the first portion 202 that may be configured to accommodate the tube 108. The first portion 202 of the webbing-type buckle 102 may include the aperture 204 that may be configured to provide a passage for the first end 214 of the tube 108. A cross section of the aperture 204 may have a rectangular shape, a circular shape, or a square shape. Further, the passage may have a cross section that may be identical to the cross section of the aperture 204.

The webbing-type buckle 102 may further include the second portion 206 that may be configured to secure the seat belt 104 of the vehicle. The second portion 206 may be different from the first portion 202 and may be adjacent to the first portion 202 of the webbing-type buckle 102. The second portion 206 of the webbing-type buckle 102 may include the slot 208 that may be configured to secure the seat belt 104 in the webbing-type buckle 102.

The tube 108 may have the first length 210. Each wire of the plurality of electric wires 110 may extend along the first length 210 of the tube 108. The plurality of electric wires 110 may have the second length 212. The internal reinforcement member 112 may be disposed along the second length 212 of the plurality of electric wires 110 inside the tube 108. In some instances, the second length 212 may be substantially equal to the first length 210. In some other instances, the second length 212 may be substantially greater than the first length 210. In some other instances, the second length 212 may be substantially less than the first length 210. It should be further noted that the diagram 200 of FIG. 2 is for exemplary purposes and should not be construed to limit the scope of the disclosure.

FIG. 3 is a diagram that illustrates a cross-sectional view of a wiring harness including an internal reinforcement member having a T-shaped cross-section, in accordance with an embodiment of the disclosure. FIG. 3 is explained in conjunction with elements from FIG. 1 and FIG. 2. With reference to the FIG. 3, there is shown a diagram 300 that illustrates the webbing-type buckle 102 having the wiring harness 106. The diagram 300 further includes the tube 108 and the plurality of electric wires 110. The diagram 300 may further includes the internal reinforcement member 112, a T-shaped cross-section 302, a vertical stem 302A, and a horizontal flange 302B.

The internal reinforcement member 112 may include the vertical stem 302A and the horizontal flange 302B at an end of the vertical stem 302A, forming the T-shaped cross-section 302. The plurality of electric wires 110 may be positioned on either side of the vertical stem 302A. The T-shaped cross-section 302 of the internal reinforcement member 112 may be configured to allow bending of the wiring harness 106 in one direction. The horizontal flange 302B may be configured to constrain the bending of the plurality of electric wires 110.

For instance, the wiring harness 106 is subjected to bending due to the movement of the user seated on the seat 100 of the vehicle. The horizontal flange 302B may constrain the bending of the plurality of electric wires 110 towards the horizontal flange 302B. The vertical stem 302A may allow bending of the wiring harness 106 along a horizontal direction. Further, the internal reinforcement member 112 may be configured to allow a larger bending radius of the wiring harness 106 that prevents premature failures of the wiring harness 106. It should be further noted that the diagram 300 of FIG. 3 is for exemplary purposes and should not be construed to limit the scope of the disclosure.

FIG. 4 is a diagram that illustrates a cross-sectional view of a wiring harness including an internal reinforcement member having a rectangular cross-section, in accordance with an embodiment of the disclosure. FIG. 4 is explained in conjunction with elements from FIG. 1, FIG. 2, and FIG. 3. With reference to the FIG. 4, there is shown a diagram 400 that illustrates the webbing-type buckle 102 having the wiring harness 106. The diagram 400 further includes the tube 108 and the plurality of electric wires 110. The diagram 400 further includes the internal reinforcement member 112 having a rectangular cross-section 402. The plurality of electric wires 110 may be positioned on either side of the internal reinforcement member 112. The rectangular cross-section 402 of the internal reinforcement member 112 may be configured to allow bending of the wiring harness 106 in one direction.

For instance, the wiring harness 106 may be subjected to bending due to the movement of the user seated on the seat 100 of the vehicle. The rectangular cross-section 402 may constrain the bending of the plurality of electric wires 110 towards the internal reinforcement member 112. The rectangular cross-section 402 may allow bending of the wiring harness 106 along a horizontal direction or a vertical direction away from the internal reinforcement member 112. Further, the internal reinforcement member 112 may be configured to allow larger bending radius of the wiring harness 106 that prevents premature failures of the wiring harness 106. It should be further noted that the diagram 400 of FIG. 4 is for exemplary purposes and should not be construed to limit the scope of the disclosure.

FIG. 5 is a diagram that illustrates a cross-sectional view of a wiring harness including an internal reinforcement member having a first circular cross-section, in accordance with an embodiment of the disclosure. FIG. 5 is explained in conjunction with elements from FIG. 1, FIG. 2, FIG. 3, and FIG. 4. With reference to the FIG. 5, there is shown a diagram 500 that illustrates the webbing-type buckle 102 having the wiring harness 106. The diagram 500 further includes the tube 108 and the plurality of electric wires 110. The diagram 500 may further includes the internal reinforcement member 112, a first circular cross-section 502, and a second circular cross-section 504.

The internal reinforcement member 112 may include the first circular cross-section 502. The tube 108 may include the second circular cross-section 504. The internal reinforcement member 112 and the plurality of electric wires 110 may be positioned off-center within the second circular cross-section 504 of the tube 108. The first circular cross-section 502 of the internal reinforcement member 112 may be configured to allow bending of the wiring harness 106 in multiple directions.

For instance, the wiring harness 106 may be subjected to bending due to the movement of the user seated on the seat 100 of the vehicle. The first circular cross-section 502 may constrain the bending of the plurality of electric wires 110 towards the internal reinforcement member 112. The rectangular cross-section 402 may allow bending of the wiring harness 106 along a horizontal direction or a vertical direction away from the internal reinforcement member 112. Further, the internal reinforcement member 112 may be configured to allow larger bending radius of the wiring harness 106 that prevents premature failures of the wiring harness 106. It should be noted that the diagram 500 shown in FIG. 5 is for exemplary purposes and should not be construed to limit the scope of the disclosure.

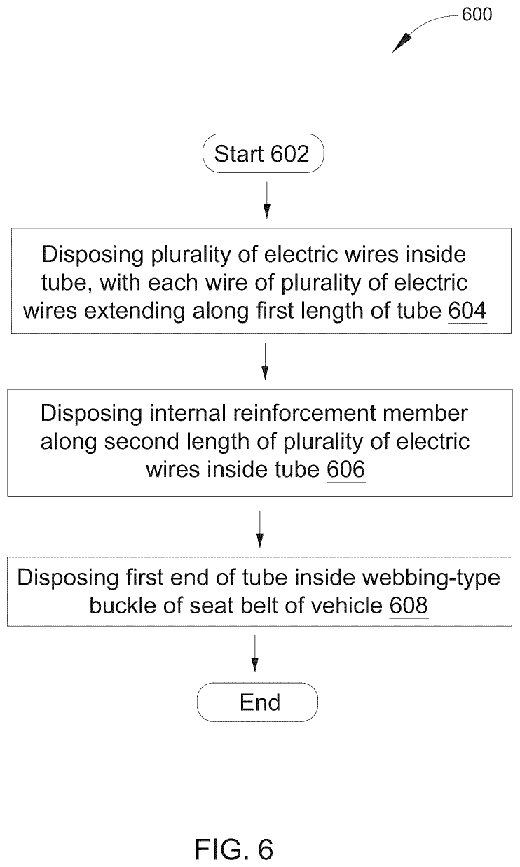

FIG. 6 is a flowchart that illustrates an exemplary method of assembling a wiring harness inside a webbing-type buckle for a vehicle, in accordance with an embodiment of the disclosure. FIG. 6 is explained in conjunction with elements from FIG. 1, FIG. 2, FIG. 3, FIG. 4, and FIG. 5. With reference to FIG. 6, there is shown a flowchart 600, which depicts a method of assembling the wiring harness 106 inside the webbing-type buckle 102 for the vehicle. The method illustrated in the flowchart 600 may start at 602 and proceed to 604.

At 604, the plurality of electric wires 110 may be disposed inside the tube 108. Each wire of the plurality of electric wires 110 may extend along the first length 210 of the tube 108, as described in detail, for example, in FIG. 1 and FIG. 2.

At 606, the internal reinforcement member 112 may be disposed along the second length 212 of the plurality of electric wires 110 inside the tube 108, as described in detail, for example, in FIG. 1 and FIG. 2.

At 608, the first end 214 of the tube 108 may be disposed inside the webbing-type buckle 102 of the seat belt 104 of the vehicle, as described in detail, for example, in FIG. 1 and FIG. 2.

Although the flowchart 600 is illustrated as discrete operations, such as 602, 604, 606, and 608, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A wiring harness for a vehicle, comprising:
a tube comprising a first end disposed inside a webbing-type buckle of a seat belt of the vehicle;
a plurality of electric wires disposed inside the tube, with each wire of the plurality of electric wires extending along a first length of the tube; and
an internal reinforcement member disposed along a second length of the plurality of electric wires inside the tube.

2. The wiring harness according to claim 1, wherein the first end of the tube is disposed inside a first portion of the webbing type buckle, and
the first portion of the webbing type buckle includes an aperture that provides a passage for the first end of the tube.

3. The wiring harness according to claim 1, wherein the webbing type buckle comprises a second portion having a slot to secure the seat belt in the webbing type buckle.

4. The wiring harness according to claim 1, wherein the second length is substantially equal to the first length.

5. The wiring harness according to claim 1, wherein a cross-sectional area of the internal reinforcement member is greater than a total cross-sectional area of the plurality of electric wires.

6. The wiring harness according to claim 1, wherein a cross-sectional area of the internal reinforcement member is less than a total cross-sectional area of the plurality of electric wires.

7. The wiring harness according to claim 1, wherein the internal reinforcement member is at least one of a plastic spine, a composite reinforcement, or a fiberglass reinforcement.

8. The wiring harness according to claim 1, wherein the internal reinforcement member is having a vertical stem and a horizontal flange at an end of the vertical stem, forming a T-shaped cross-section, and
the plurality of electric wires is positioned on either side of the vertical stem and the horizontal flange is configured to constrain a bending of the plurality of electric wires.

9. The wiring harness according to claim 1, wherein the internal reinforcement member is having a rectangular cross-section, and
the plurality of electric wires is positioned on either side of the internal reinforcement member.

10. The wiring harness according to claim 1, wherein the internal reinforcement member is having a first circular cross-section, and
the internal reinforcement member and the plurality of electric wires are positioned off-center within a second circular cross-section of the tube.

11. A webbing type buckle of a seat belt of a vehicle, comprising:
a wiring harness that includes:
a tube comprising a first end disposed inside a webbing-type buckle of a seat belt of the vehicle;
a plurality of electric wires disposed inside the tube, with each wire of the plurality of electric wires extending along a first length of the tube; and
an internal reinforcement member disposed along a second length of the plurality of electric wires inside the tube.

12. The webbing type buckle according to claim 11, wherein the first end of the tube is disposed inside a first portion of the webbing type buckle, and
the first portion of the webbing type buckle includes an aperture that provides a passage for the first end of the tube.

13. The webbing type buckle according to claim 11, wherein the webbing type buckle comprises a second portion having a slot to secure the seat belt in the webbing type buckle.

14. The webbing type buckle according to claim 11, wherein the second length is substantially equal to the first length.

15. The webbing type buckle according to claim 11, wherein a cross-sectional area of the internal reinforcement member is greater than a total cross-sectional area of the plurality of electric wires.

16. The webbing type buckle according to claim 11, wherein a cross-sectional area of the internal reinforcement member is less than a total cross-sectional area of the plurality of electric wires.

17. The webbing type buckle according to claim 11, wherein the internal reinforcement member is having a vertical stem and a horizontal flange at an end of the vertical stem, forming a T-shaped cross-section, and
the plurality of electric wires is positioned on either side of the vertical stem and the horizontal flange is configured to constrain a bending of the plurality of electric wires.

18. The webbing type buckle according to claim 11, wherein the internal reinforcement member is having a rectangular cross-section, and
the plurality of electric wires is positioned on either side of the internal reinforcement member.

19. The webbing type buckle according to claim 11, wherein the internal reinforcement member is having a first circular cross-section, and
the internal reinforcement member and the plurality of electric wires are positioned off-center within a second circular cross-section of the tube.

20. A method of assembling a wiring harness inside a webbing-type buckle for a vehicle, the method comprising:
disposing a plurality of electric wires inside a tube, with each wire of the plurality of electric wires extending along a first length of the tube;
disposing an internal reinforcement member along a second length of the plurality of electric wires inside the tube; and
disposing a first end of the tube inside the webbing-type buckle of a seat belt of the vehicle.
